(19) United States
(12) Patent Application Publication
(10) Pub. No.: US 2007/0101140 A1
(43) Pub. Date: May 3, 2007

(54) Generation and validation of diffie-hellman digital signatures

(75) Inventor: Steven Charles Rhoads, Carmel, IN (US)

Correspondence Address: Joseph S Tripoli;Thomson Licensing Inc, Patent Operations, P O BOx 5312, Princeton, NJ, 08543-5312, US

(73) Assignee: Thomas Licensing, Inc.

(21) Appl. No.: 10/560,972

(22) PCT Filed: Jul. 31, 2003
(86) PCT No.: PCT/US03/24000

§ 371 Date: Dec. 15, 2005

(51) Int. Cl. H04L 9/00

(52) U.S. Cl. 713/171

(57) ABSTRACT

In one embodiment, a device for decoding digital signatures to validate the source of received information items is disclosed. The device is operable to determine a first comparator value in relation to a first value associated with information items received over a network and a Diffie-Hellman public key, determine a second comparator value in relation to a digital signature received, wherein the digital signature is determined in association with a second value associated with the information items prior to transmission over said network, and com paring the first and second comparator values to validate the source based on the comparison. In another embodiment, a key generating device is operable to generate a first and second Diffie-Hellman key from a plurality of large numbers randomly selected, wherein at least one of the numbers is a prime number, and further determine a public key as a Diffie-Hellman transpose of one of the generated first and second Diffie-Hellman keys.

### FIELD OF THE INVENTION

This application is related to the field of cryptography, and more specifically to a system and device that operates to generate and/or validate digital signatures using a Diffie-Hellman based algorithm.

### BACKGROUND

Digital signature technologies that verify whether or not a file has come from an authorized or trusted source are well known in the art. For example, using a public/private key encryption system, a sender may electronically sign a document by scrambling or encrypting the contents of an associated file using a locally available, and secretly held, private key. The receiving party may, using the sender's public key, decrypt the received file. The ability of the receiving party to properly descramble or decrypt the received file validates that the file was sent by an authorized or trusted sender.

FIG. 1 illustrates a block diagram 100 of a system for creating a digital signature. As shown, file 110 is provided to a “hashing” algorithm 120 that generates and associates a value with the file. For example, SHA-1 (Secure Hashing Algorithm) can create a 160-bit hash value for any file. It can be further shown that it is computationally infeasible to create two files that have the same hash value. The hashed value is then encrypted or scrambled using, for example, an RSA private encryption key of the sending party, at block 130. In this case, the encrypted or scrambled hash value is representative of a digital signature. The file and the signature are transmitted over network 150.

A receiving party receives the file 160 and the encrypted hash value, i.e., digital signature, decrypts or descrambles the digital signature using the associated RSA public key, at block 180, and hashes the file, at block 170, to generate a re-calculated hash value. A comparison is made, at block 190, to determine whether the decrypted hash value is the same as the calculated hash value.

While the use of the above-described public/private key system provides a certain measure of security, such a system may be vulnerable to intensive mathematical computational attack. Furthermore, existing digital signature techniques may have somewhat limited usability, as encryption technologies are subject to certain export restrictions. Alternative validation techniques are desired.

### SUMMARY

A method and associated devices for generating and decoding digital signatures to validate the source of received information items is disclosed. The receiving device is operable to determine a first comparator value in relation to a first value associated with an information item received over a network and a Diffie-Hellman public key, determine a second comparator value in relation to a digital signature received, wherein the digital signature is determined in association with a second value associated with the information item prior to transmission over the network, compare the comparator values and validate that the information was sent by the source based on the comparison. The key generating device is operable to generate a first and second Diffie-Hellman public key from a plurality of large numbers randomly selected, wherein at least one of the numbers is a prime number and further determine a public key as a Diffie-Hellman transpose of one of the generated Diffie-Hellman public keys.

### BRIEF DESCRIPTION OF THE DRAWINGS

FIG. 1 illustrates a block diagram of a process for conventional RSA digital signature processing;

FIG. 2 illustrates a block diagram of a process for validating a user's identity in accordance with an aspect of the present invention;

FIG. 3 illustrates a flow chart of an exemplary process for generating a digital signature in accordance with an aspect of the present invention;

FIG. 4 illustrates a flow chart of an exemplary process for decoding a digital signature in accordance with an aspect of the invention; and

FIG. 5 illustrates a device for executing the processing shown herein.

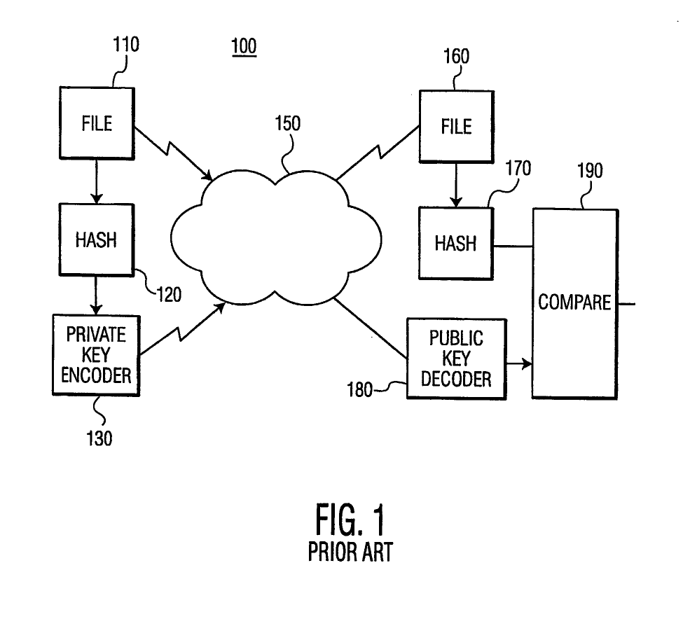

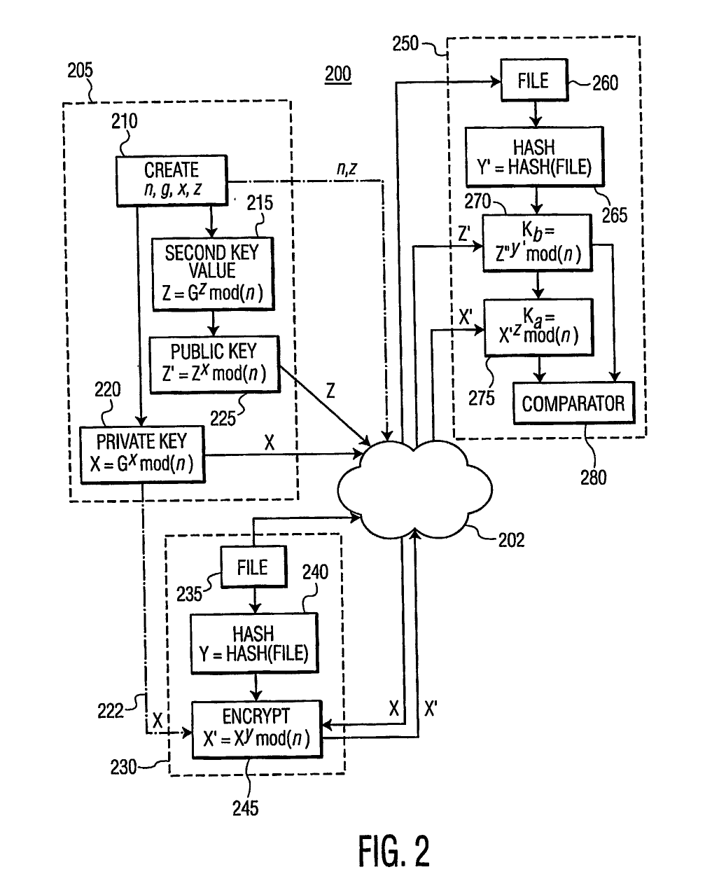

It is to be understood that these drawings are solely for purposes of illustrating the concepts of the invention and are not intended as a definition of the limits of the invention. The embodiments shown in FIGS. 2-5 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION

The use of a Diffie-Hellman algorithm in encryption technology has been expanded to three parties as is more fully explained in “Applied Crytography 2^{nd} edition” Bruce Schneier (Ed.), p. 514. In this encryption technology, each party transfers elements of a key that are provided by another party. A common encryption key is determined for the session by each party based on the information provided. For example, assuming that the encryption variables g and n, where n is a large prime number, are known to each party, it can be shown that a three party key exchange can be formed using the following process:

“A” randomly selects a large integer x, forms X=g^{x} mod(n) and transmits X to “B”;

“B” randomly selects a large integer y, forms Y=g^{y} mod(n) and transmits Y to “C”; and

“C” randomly selects a large integer z, forms Z=g^{z} mod(n); and transmits Z to “A”;

“A” then creates a transform of Z as Z′=Z^{x} mod(n) and transmits Z′ to “B”;

“B” then creates a transform of X as X′=X^{y} mod(n) and transmits X′ to “C”; and

“C” then creates a transform of Y as Y′=Y^{z} mod(n) and transmits Y′ to “A”.

“A” then determines key value, k, as k=Y′^{z} mod(n);

“B” then determines key value, k, as k=Z′^{y} mod(n); and

“C” then determines key value, k, as k=X′^{z} mod(n).

The ability of “A,” “B,” and “C” to each determine common key value, k, may be shown mathematically as: [symbol] [symbol]
g^{x}mod(n) [symbol] ^{y}mod(h) [symbol] ^{z}mod(n)=g^{xyz}mod(n)= [symbol] z,900 g^{y}mod(n) [symbol] ^{z}mod(n) [symbol] ^{x}mod(n) [1]

FIG. 2 illustrates a block diagram of an exemplary operation 200 for generating a digital signature in accordance with an aspect of the present invention. A first party “A”, represented as block 205, generates encryption values, n, g, x, and z at block 210. Encryption values, n, g, x, and z preferably are each randomly selected large numbers and n is a prime number. Values n and z are transmitted over network 202. Values g and x are maintained in confidence by party “A.” At block 220 a first key value is generated as X=g^{x} mod(n) and is representative of party “A”'s private key, for use by second party “B”. In a preferred embodiment, private key X is transmitted to party “B” via a secure link, such as physical delivery, represented by dashed line 222. In another aspect of the invention, private key X may be transmitted from party “A” to party “B” over network 202 using secure aspects of network 202 between parties “A” and “B”. Such secure aspects include secure communication provisions, such as passwords and shared keys, for example.

At block 215 a second key value is generated as Z=g^{z}mod(n) and at block 225 second key value Z is transformed into a public key as Z′=Z^{x}mod(n). Public key Z′ is then delivered to third party “C”. In the example shown, public key Z′ is transmitted over network 202. Although not shown, it would be recognized by those skilled in the art that when public key Z′ is transmitted over a public network, provisions are included, for example, signatures, certificates and the like, that are used to assure a receiving party that public key Z′ is transmitted from a trusted source. Hence, independent means for validating public key Z′ are needed when distribution is made over a public network, such as the Internet. In another aspect of the invention, public key Z′ is a known, preloaded or predetermined value at the site representative of third party “C”.

Second party “B”, represented as block 230, hashes an information item or a file 235 at block 240 to produce a hash value, referred to as “y”. The hash value y is then used to determine a digital signature, X′, using private key X and encryption variable, n, as x′=X^{y} mod(n) at block 245. File 235 and signature X′ ate then transmitted over network 202.

Third party, “C”, represented as block 250, receives file 235, shown as block 260, and computes a hash value of the received file at block 265 using methods comparable to those used for determining a hash value as previously discussed. The computed hash value is referred to as “y′”. A first comparator value is then formulated using public key Z′ and computed hash value y′ as:
K_{b}=Z′^{y}mod(n). [2]

Third party “C” further generates a second comparator value (Kₐ) at block 275 from the received digital signature X′ and the encryption variable z as:
Kₐ=X′^{z}mod(n). [3]

At block 280 a comparison is performed to validate the source of the transmission. The validity of the source of the information item or file transmitted, i.e., second party “B”, is assured when the value of the hash value of the file before transmission (y) equals the hash value of the received file (y′). In this case, the comparator values, Kₐ and K_{b}, can be shown to be equal as:
Kₐ=X′^{z}mod(n)=(X^{y}mod(n))^{z}mod(n)=((g^{x}mod(n))^{y}mod(n))^{z}mod(n)=g^{xyz}mod(n); [4]
K_{b}=Z′^{y′}mod(n)=(Z^{x}mod(n))^{y′}mod(n)=((g^{z}mod(n))^{x}mod(n))^{y′}mod(n)=g^{xy′z}mod(n); [5]

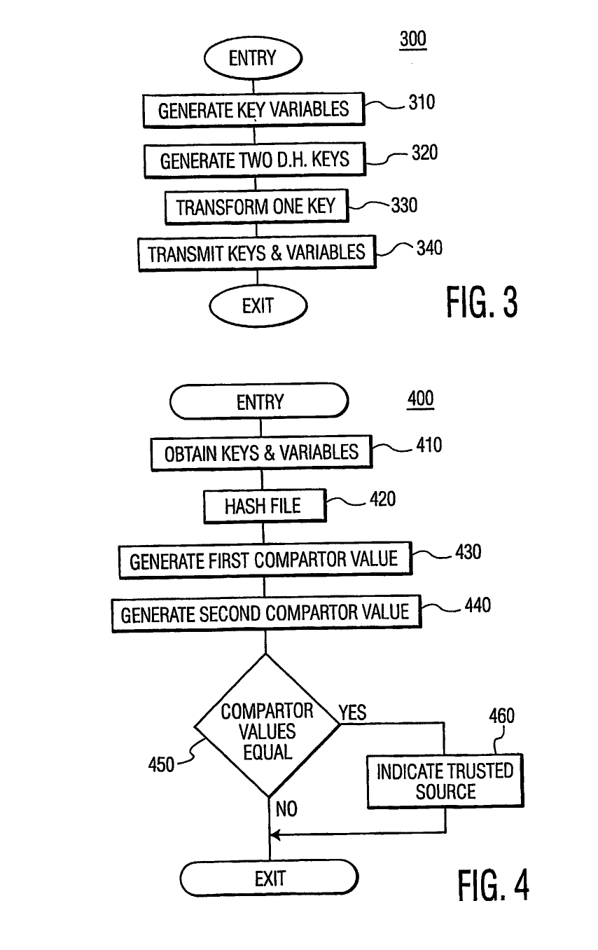

FIG. 3 illustrates a flow chart of a process 300 for generating key values in accordance with an aspect of the present invention. In this illustrative process, key variables g, n, x and z are generated at block 310. At block 320, two keys are generated as:
X=g^{x}mod(n) and Z=g^{z}mod(n); [6]

At block 330, one of the generated keys is transformed into a public key as:
Z′=Z^{x}mod(n). [7]

At block 340, selected ones of the encryption variables, e.g., n and z, are transmitted over the network. In one aspect, a first key, X, and public key, Z′, may be transmitted over a secure portion of a network. In another aspect, first key X and public key Z′ may be preloaded or predetermined and hence, known, by parties “B” and “C.”

FIG. 4 illustrates a flow chart of a process 400 for validating the digital signature in accordance with an aspect of the present invention. In this exemplary process, the key values and encryption variables are obtained at block 410. As previously discussed, the keys and variables may be transmitted over secure networks, electronically or-physically, or reloaded or prestored. At block 420, a hash value is determined for the received file. At lock 430, a first comparator value is determined based upon the determined hash value. At lock 440, a second comparator value is determined. At block 450, a determination is made whether the determined first and second comparator values are the same. If the answer is in the affirmative, then at block 460, an indication is generated that indicates that second party “B” sent the received file.

Although not shown, it would be recognized by those skilled in the art that encryption variables n, g, x and z may be predetermined and known by respective parties. Hence, these values need not be transmitted over the network. In this case, in a system wherein first party “A” is a factory producing set-top boxes, each set-top box or device may be preloaded or preset with the generated encryption key, Z′, and variables n and z. In this case, each set-top box would be representative of party “C”. Similarly, second party “B” may be a transmission device, such as a cable company or other media content service, referred to as a “head-end”. In this case, first party A need provide only a minimum amount of information to second party B for party B to create a digital signature, X′.

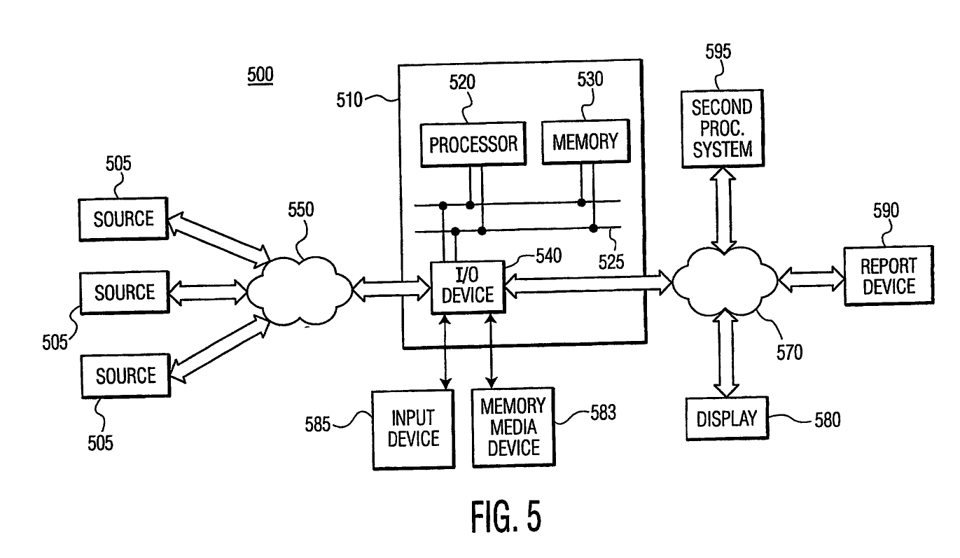

FIG. 5 illustrates a system 500 for implementing the principles of the invention as depicted in the exemplary processing shown in FIGS. 2-4. In this exemplary system embodiment 500, input data is received from sources 505, such as over network 550, and is processed in accordance with one or more programs executed by processor 520 of processing system 510. The results of processing system 510 may then be transmitted over network 570 for viewing on display 580, reporting device 590 and/or a second processing system 595.

Specifically, processing system 510 includes one or more input/output devices 540 that receive data from the illustrated source devices 505 over network 550. The received data is then applied to processor 520, which is in communication with input/output device 540 and memory 530. Input/output device 540, processor 520 and memory 530 may communicate over a communication medium 525. Communication medium 525 may represent a communication network, e.g., ISA, PCI, PCMCIA bus, one or more internal connections of a circuit, circuit card or other device, as well as portions and combinations of these and other communication media. Processor system 510 or processor 510 may be representative of a handheld calculator, special purpose or general purpose processing system, desktop computer, laptop computer, palm computer, or personal digital assistant (PDA) device, etc., as well as portions or combinations of these and other devices that can perform the processing illustrated.

Processor 520 may be a central processing unit (CPU) or dedicated hardware/software, such as a PAL, ASIC, FGPA, operable to execute computer instruction code or a combination of code and logical operations. In one embodiment, processor 520 may include code which, when executed, performs the operations illustrated herein. The code may be contained in memory 530 or may be read or downloaded from a medium such as a CD-ROM or floppy disk represented as 583, or provided by manual input device 585, such as a keyboard or a keypad entry, or read from a magnetic or optical medium (not shown) which is accessible by processor 520, when needed. Information items provided by input device 583, 585 and/or magnetic medium may be accessible to processor 520 through input/output device 540, as shown. Further, the data received by input/output device 540 may be immediately accessible by processor 520 or may be stored in memory 530. Processor 520 may further provide the results of the processing shown herein to display 580, recording device 590 or a second processing unit 595 through I/O device 540.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operation illustrated in FIGS. 24 may be performed sequentially or in parallel using different processors to determine specific values. Processor system 510 may also be in two-way communication with each of the sources 505. Processor system 510 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 550 and 570 may also be internal networks or one or more internal connections of a circuit, circuit card or other device, as well as portions and combinations of these and other communication media or an external network, e.g., the Internet and Intranet. As would be recognized by those skilled in the art, processing system 510 maybe representative of a device suitable for operation as second party “B” or third party “C”.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, it would be recognized by those skilled in the art that a 160 bit hash value may not be large enough to provide sufficient security. In this case, it may be advantageous to further extend the range of the hash value by performing an expanding function on the value. For example, in one aspect, a larger hash value may be determined by raising the 160 bit hash value obtained from the SHA-1 algorithm noted above to a known power, i.e. (hash value)^{a}. In a preferred embodiment, a is selected greater than 7.

It is expressly intended that all combinations of those elements that perform substantially the same function in substantially the same way to achieve the same results are within the scope of the invention. Substitutions of elements from one described embodiment to another are also fully intended and contemplated.

1. A device, located at a remote site on a network having a plurality of remote sites, for validating the source of an information item transmitted over said network, said device comprising:
a processor in communication with a memory, said processor operable to execute code for:
determining a first comparator value in relation to a first value associated with said information item received over said network and a Diffie-Hellman public key;
determining a second comparator value in relation to a digital signature received, said digital signature determined in association with a second value associated with said information item prior to transmission over said network; and
comparing said first and second comparator values and validating said source based on said comparison.

2. The device as recited in claim 1, wherein said processor is further operable to execute code for determining said first value as a hash value of said received information items.

3. The device as recited in claim 1, wherein said public key is in the form of
g^{xz}mod(n)
wherein g, x, z, and n are randomly selected large numbers and n is a prime number.

4. The device as recited in claim 3, wherein said public key is selected from the group consisting of: known, preloaded, pre-determined, determinable.

5. The device as recited in claim 3, wherein said processor is operable to read said public key from an external media consisting of: magnetic tape, optic, memory.

6. The device as recited in claim 3, wherein said processor is operable to execute code for receiving selected ones of said randomly selected large numbers over said network.

7. The device as recited in claim 1, wherein said processor is further operable to execute code for receiving said public key over said network.

8. The device as recited in claim 3, wherein said processor is further operable to obtain selected ones of said randomly selected large numbers from preloaded sources from the group consisting of: magnetic tape, optic medium, memory.

9. The device as recited in claim 1, further comprising:
an I/O unit in communication with said processor and said network.

10. The device as recited in claim 9, wherein said I/O unit is further in communication with said memory.

11. The device as recited in claim 1, wherein said code is stored in said memory.

12. The device as recited in claim 1, wherein said second value is a hash value.

13. The device as recited in claim 1, wherein said source is validated when said first and second comparator values are equal.

14. A method for validating the source of an information item transmitted over a network, said method comprising the steps of:
determining a first comparator value in relation to a first value associated with said information item transmitted over said network and a Diffie-Hellman public key;
determining a second comparator value in relation to a digital signature, wherein said digital signature is associated with said information items prior to transmission over said network; and
comparing said first and second comparator values and validating said source based on said comparison.

15. The method as recited in claim 14, further comprising the step of:
determining said first value as a hash value of said information items.

16. The method as recited in claim 14, wherein said public key is in the form of:
g^{xz}mod(n)
wherein g, x, z, and n are said randomly selected large numbers and n is a prime number.

17. The method as recited in claim 16, wherein said pubic key is selected from the group consisting of: known, preloaded, predetermined, determinable.

18. The method as recited in claim 16, wherein said public key is transmitted over said network.

19. The method as recited in claim 16, wherein selected ones of said large number values are selected from the group consisting of: known, preloaded, predetermined.

20. The method as recited in claim 16, wherein selected ones of said large number values are received from said network.

21. The method as recited in claim 14, wherein said source is validated when said first and second comparator values are equal.

22. A device for generating digital signatures comprising:
a processor in communication with a memory, said processor operable to execute code for:
generating a first and second Diffie-Hellman public key from a plurality of large numbers randomly selected, wherein at least one of said numbers is a prime number; and
determining a public key as a Diffie-Hellman transpose of one of said Diffie-Hellman public keys.

23. The device as recited in claim 22, further comprising:
a device in communication with said processor, said device operable to transmit said public key and a remaining one of said Diffie-Hellman public keys to an external device.

24. The device as recited in claim 23, wherein said external device is selected from the group consisting of: a network, a magnetic medium, an optical medium, human-readable media.
